(19) United States
(12) Patent Application Publication
(10) Pub. No.: US 2026/0128512 A1
(43) Pub. Date: May 7, 2026

(54) PHASE SHIFTER

(71) Applicant: Suzhou Luxshare Technology Co., Ltd., Suzhou City (CN)

(72) Inventors: KANGNING LV, Suzhou City (CN); ZHENGGUO ZHOU, Suzhou City (CN); HUI CAO, Suzhou City (CN); GANG ZHOU, Suzhou City (CN); QIANG LI, Suzhou City (CN)

(73) Assignee: Suzhou Luxshare Technology Co., Ltd., Suzhou City (CN)

(21) Appl. No.: 19/373,988

(22) Filed: Oct. 30, 2025

(30) Foreign Application Priority Data
Nov. 6, 2024 (CN) 202411578470.6

(51) Int. Cl. H01Q 3/26; F16H 19/04

(52) U.S. Cl. CPC H01Q 3/26; F16H 19/04

(57) ABSTRACT

Provided is a phase shifter including: a supporting board, a circuit board, a transmission structure, and an adjusting structure. The circuit board and the transmission structure are disposed on two sides of the supporting board. The adjusting structure is rotatably connected to the circuit board and the supporting board. The transmission structure includes a gear, a gear rack and an arc-shaped internal gear. The gear is engaged with the gear rack and the arc-shaped internal gear. The arc-shaped internal gear is connected to the adjusting structure. The circuit board is provided with a first strip line. The adjusting structure is provided with a second strip line. The gear rack moves to drive the gear to rotate and further drives the arc-shaped internal gear to rotate. The adjusting structure rotates along with the arc-shaped internal gear, such that the second strip line contacts different positions of the first strip line.

### CROSS-REFERENCE TO RELATED APPLICATION

This application claims the benefit of Chinese Patent Application No. 202411578470.6, filed on Nov. 6, 2024, entitled “Phase Shifter”, which is incorporated herein by reference in its entirety.

### FIELD

The present disclosure relates to the field of base station antenna, and more particularly to a phase shifter.

### BACKGROUND

Operation parameters of a mobile communication Electronic Speed Control (ESC) antenna can be adjusted without physical movement. Control personnel may change a phase of an internal phase shifter and adjust an inclination of a radiation beam by remotely controlling a transmission system, and thereby adjust a coverage region of a network. At present, a sector phase shifter is widely used. At present, a motor drives a screw to move straightly, and the straight movement of the screw drives a sliding connector to slide or drives a gear rack disposed on an outer side of a circuit board to slide. In this way, the straight movement is converted to a circular movement of the sector phase shifter.

However, the phase changing in the above transmission is difficulty to precisely control. In addition, connection elements are stacked above the phase shifter, occupy spaces, and even cover strip lines of the phase shifter, thereby affecting the performance. In addition, since the sliding connector and an arc-shaped external gear that is engaged with the gear rack are disposed above the circuit board of the phase shifter, the required sliding distance of the sliding connector is associated with a radius of the circuit board. Different phase shifters have different moving distances, and the difference between these moving distances may be large, which hinders corporation of multiple phase shifters.

### SUMMARY

Embodiments of the present disclosure provide a phase shifter. The phase shifter provided by embodiments of the present disclosure includes a supporting board, a circuit board, a transmission structure, and an adjusting structure. The circuit board is disposed on an outer side of the supporting board, and a first strip line for phase shifting is disposed on the circuit board. The transmission structure is disposed on a side of the supporting board away from the circuit board. The transmission structure includes a gear, a gear rack and an arc-shaped internal gear. The gear is rotatably connected to the supporting board and is engaged with the gear rack and the arc-shaped internal gear. The gear rack and the arc-shaped internal gear are disposed on a same side of the gear. The adjusting structure is disposed on an outer side of the circuit board and rotatably connected to the circuit board and the supporting board. An end of the adjusting structure is connected to an outer side of the arc-shaped internal gear, and a side of the adjusting structure in contact with the circuit board is provided with a second strip line which is and in contact with and electrically connected to the first strip line. The gear rack moves along its length direction and drives the gear to rotate, the gear drives the arc-shaped internal gear to rotate, and the adjusting structure rotates following the rotation of the arc-shaped internal gear to cause the second strip line to contact the first strip line at different positions to realize phase shifting.

### BRIEF DESCRIPTION OF THE DRAWINGS

The various features and advantages of the disclosed examples will become apparent to those skilled in the art from the detailed description. The figures that accompany the detailed description can be briefly described as follows:

FIG. 1 is a schematic structural view of an existing sector phase shifter;

FIG. 2 is a schematic structural view of another existing sector phase shifter;

FIG. 3 is an exploded view of a phase shifter including a first strip line according to an embodiment of the present disclosure;

FIG. 4 is a schematic structural view of a phase shifter in a vertical “one-driving-two” mode according to an embodiment of the present disclosure;

FIG. 5 is a schematic view of relationship between a transmission structure and an adjusting structure according to an embodiment of the present disclosure;

FIG. 6 is a schematic view of relationship between the transmission structure and the adjusting structure with the gear rack being omitted according to an embodiment of the present disclosure;

FIG. 7 is a schematic view of the transmission structure according to an embodiment of the present disclosure;

FIG. 8 is an upward view of the adjusting structure according to an embodiment of the present disclosure;

FIG. 9 is an exploded view of the adjusting structure according to an embodiment of the present disclosure;

FIG. 10 is a schematic view of a phase shifter with the circuit board and the adjusting structure being omitted according to an embodiment of the present disclosure;

FIG. 11 is a schematic view of a phase shifter including one circuit board of a first strip line according to an embodiment of the present disclosure;

FIG. 12 is a schematic front view of a phase shifter in a horizontal “one-driving-two” mode according to an embodiment of the present disclosure;

FIG. 13 is a schematic back view of the phase shifter in the horizontal “one-driving-two” mode according to an embodiment of the present disclosure;

FIG. 14 is a schematic front view of a phase shifter in a “one-driving-four” mode according to an embodiment of the present disclosure; and

FIG. 15 is a schematic view of the phase shifter in the “one-driving-four” mode with the circuit board and the supporting board on one side being omitted according to an embodiment of the present disclosure.

### DETAILED DESCRIPTION OF EMBODIMENTS

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, it should be understood by those skilled in the art, the drawings herein are provided for the purpose of illustration, and the drawings are not necessarily to scale.

Unless otherwise stated, the terms “comprise”, “include” and the like in the entire application document shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

Unless otherwise stated or defined, the terms “install”, “connected”, “connect”, “fix” and the like should be understood in a broad sense, for example, the term “connected” may be fixedly connected or detachably connected or integrally connected, may be mechanically connected or electrically connected, may be directly connected or indirectly connected by means of an intermediate medium, and may be internally communicated or have an interaction relationship between two elements. A person skilled in the art can understand the specific meanings of the above terms in the present disclosure according to specific circumstances.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Mobile communication ESC antenna is an antenna capable of adjusting its operation parameters without physical movement. The operation parameters are adjusted by changing a position of a ground terminal of a phase shifter. In an antenna, current forms node and antinode. Changing of ground terminal causes position changing of the node and antinode of the current, and thus cause changing of a phase of a signal of the antenna. The phase shifter is used for adjusting the phase of the signal. For the ESC antenna, the position of the ground terminal may affect an effective length of the antenna. The effective length affects resonant properties of the antenna, and determines an operation frequency and radiation properties of the antenna. At present, the phase shifter includes the following types: a cavity-type phase shifter, a sector phase shifter, and the like. The sector phase shifter has a simple structure, low cost, high reliability, and has been widely used.

The phase shifter changes the effective length of the antenna to change the current distribution of the antenna and thus to change the phase properties of the ESC antenna. For example, a surface of a circuit board 2 of the ESC antenna is provided with a first strip line 21, two ends of the first strip line 21 are respectively an input port and an output port of an electrical signal, a ground terminal is arranged on a second strip line 43 provided on an inner side of a sliding plate, and the second strip line 43 and the first strip line 21 are in contact with each other and electrically connected to each other. The first strip line 21 and the circuit board 2 of the sector phase shifter each have an arc-shaped edge, and the arc-shaped edges of the first strip line 21 and the circuit board 2 have the same arc configuration manner. By changing the position where the ground terminal is connected to the circuit (an end of the sliding plate moves along the arc-shaped edge of the circuit board 2), the contact point between the first strip line 21 and the second stripe line 43 moves along the first strip line 21, and thus, the position of the phase shifter changes. The movement of the sliding plate is controlled by the transmission structure 3. The phase of the core part phase shifter is changed by remotely controlling the transmission structure 3, the inclination of the radiation beam is adjusted, and a coverage region of a network is adjusted accordingly.

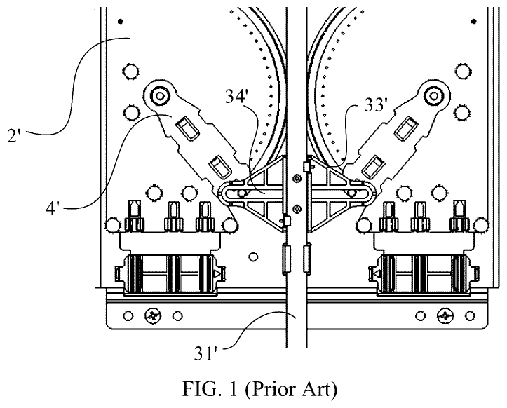

In the existing sector phase shifter, a motor drives a screw to move straightly, thereby driving a movable bar 31′ connected to the screw or a rock bar 32′ disposed on an outer side of the circuit board 2′ to slide. As shown in FIG. 1, for the sector phase shifter including the movable bar 31′, the movable bar 31′ is provided with a sliding connector 33′, the sliding connector 33′ is fixed to the movable bar 31′ and slides with the movable bar 31′, the sliding connector 33′ is disposed between two fan-shaped circuit boards 2 arranged in parallel, sliding plates 4′ rotates on the two circuit boards 2′ respectively, and an end of each of the sliding plates 4′ slides in a sliding slot 34′ of the sliding connector 33′. That is, when the sliding connector 33′ slides, the sliding plates 4′ on two sides of the sliding connector 33′ are pushed to rotate towards the moving direction of the sliding connector 33′. However, the sliding slot 34′ only pushes the rotation of the sliding plates 4′. In order to avoid that a large resistance force blocks the movement of the sliding plates 4′, the sliding slot 34′ is provided with a transmission vacancy, and thus, the sliding slot 34′ is difficulty to strictly limit the sliding of one end of the sliding plate 4′ in the sliding slot 34′, and the phase changing is difficulty to precisely control.

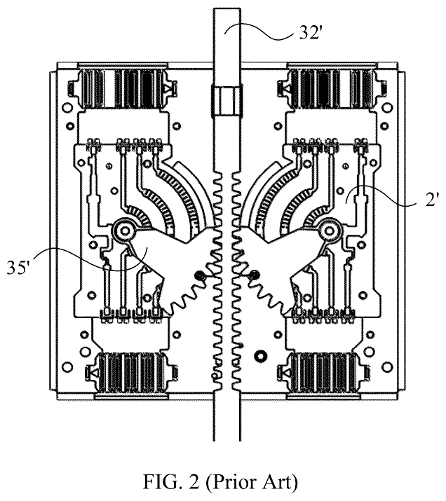

As shown in FIG. 2, for the sector phase shifter including the gear rack 32′ disposed on the outer side of the circuit board 2′, it needs to ensure that the distance of the rotation of the sliding plate 4′ can cover the entire length of the first strip line. The arc-shaped external gear 35′ cooperating with the gear rack 32′ has a large size. In some cases, the arc-shaped external gear 35′ may cover the first strip line, affecting the performance of the sector phase shifter. In addition, the sliding connector 33′ and the gear rack 32′ are both disposed above the surface of the circuit board 2′ and connected to an end of the sliding plate 4′, and the length of the movement distance of the screw actually depends on the radius of the arc-shaped edge of the circuit board 2′. Therefore, the lengths of the movement distances of phase shifters having different sizes are different, and the difference is significant, which is adverse to cooperation of multiple phase shifters. In view of the above, it is necessary to avoid backlash in the transmission structure of the phase shifter, improve the reliability, reduce the influence of the size of the circuit board 2′ on the size of the transmission structure, and realize miniaturization and modular design.

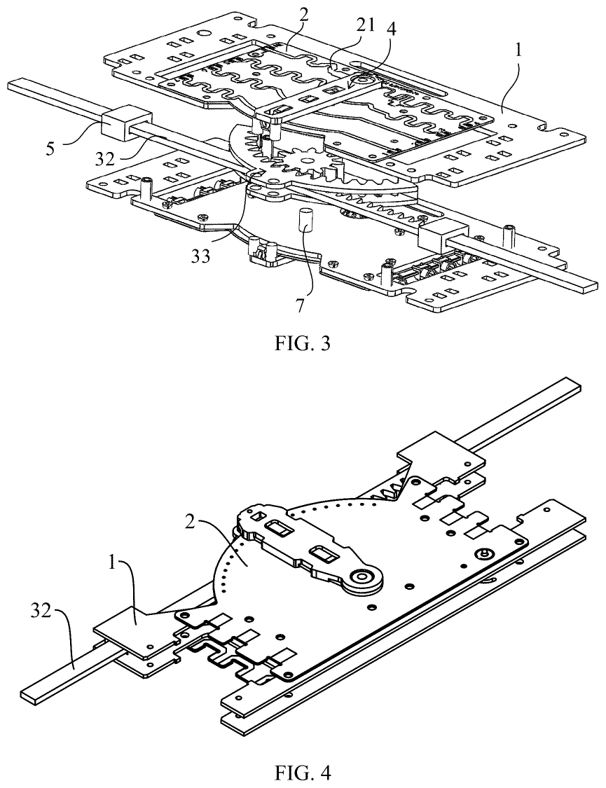

FIG. 3 and FIG. 4 respectively show two different appearances of a phase shifter provided by the present disclosure. FIG. 3 is an exploded view showing the structure of the phase shifter.

As shown in FIG. 3, FIG. 4 and FIG. 8, the phase shifter provided by embodiments of the present disclosure includes a supporting board 1, a circuit board 2, a transmission structure 3, and an adjusting structure 4. The supporting board 1 provides supporting function for installation and movement of other components. When the phase shifter is connected to another structure of an external Remote Electrical Tilting Antenna, the supporting board 1 provides supporting for other components of the phase shifter. The circuit board 2 is disposed on an outer side of the supporting board 1, and has a surface facing the outer side. The circuit board 2 includes a first strip line 21 on the surface facing the outer side, and the first strip line 21 is configured to contact the adjusting structure. One side of the circuit board 2 is formed into an arc-shaped edge. A side edge of the supporting board 1 follows the shape of this side edge of the circuit board 2, thereby facilitating the rotation of the adjusting structure 4 for phase shifting. According to actual conditions, selection may be made from different supporting boards 1 and circuit boards 2 shown in FIG. 3 and FIG. 4. The transmission structure 3 is disposed on a side of the supporting board 1 away from the circuit board 2. The transmission structure 3 includes a gear 31, a gear rack 32 and an arc-shaped internal gear 33. The arc-shaped internal gear 33 is connected to the adjusting structure 4. The transmission gear 31 is driven by an external structure such as a screw. The gear 31 is engaged with the gear rack 32 and the arc-shaped internal gear 31. The gear 31 drives the adjusting structure 4 to move on the circuit board 2 to change a contact point between the first strip line 21 and the second strip line 43 of the adjusting structure 4, thereby changing the phase of the electrical tilting antenna. According to actual conditions, the phase shifter further includes two limiting members 5 (a first limiting member and a second limiting member) which are connected to two ends of the supporting board 1 respectively. Two ends of the gear rack 32 movably runs through the two limiting members 5 respectively. Therefore, the movement of the gear rack 32 along a straight line defined by the two limiting member 5 is restricted.

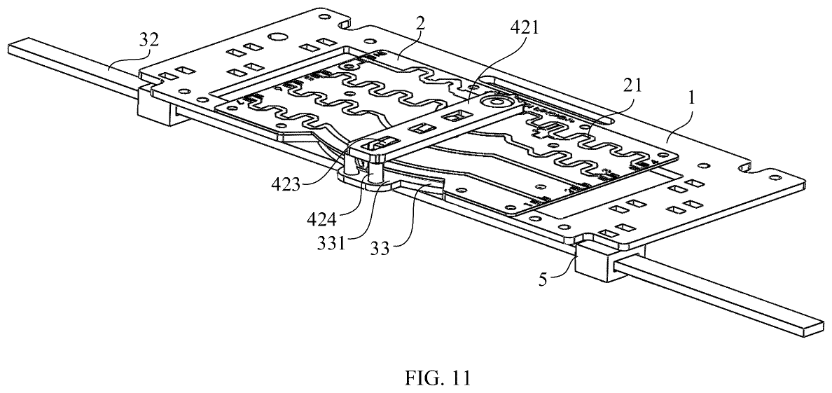

As shown in FIG. 8 and FIG. 10, the adjusting structure 4 is disposed on the outer side of the circuit board 2 and is rotatably connected to the circuit board 2 and the supporting board 1. In some embodiments, a rotating shaft 6 is used as the rotating shaft of the adjusting structure 4, and each of two ends of the rotating shaft 6 is provide with an elastic snap fastener. The second strip line 43 is provided on a side, contacting the circuit board 2, of the adjusting structure 4. The second strip line 43 is in contact with the first strip line 21 to be electrically connected to the first strip line 21. An end of the second strip line 43 is electrically connected to an external structure and is grounded. That is, the second strip line 43 is a grounding terminal of the phase shifter. The engagement relationship in the transmission structure 3 avoids backlash. Therefore, phase changing is accurately controlled, and the reliability of the phase shifter is improved. The transmission structure 3 and the adjusting structure 4 are disposed on two sides of the circuit board 2 respectively. As a result, the transmission structure 3 does not cover the first strip line 21 and does not affecting the performance of the phase shifter. In addition, since the gear 31 is engaged with both the gear rack 32 and the arc-shaped internal gear 33, a length of the gear rack 32 is only related to the gear 31, and is not related to the arc-shaped internal gear 33 and the radius of the arc-shaped part of the circuit board 2. Therefore, the phase shifter can be designed with higher modularity, and cooperation between multiple phase shifters is facilitated, and the reliability is further improved.

As shown in FIG. 3, the first strip line 21 is arranged in the same arc shape as the arc-shaped edge of the circuit board 2. In some embodiments, the arc of the first strip line 21 and the arc of the edge of the circuit board 2 share the same circle center. The first strip line 21 extends to two ends of the circuit board 2 and is electrically connected to an input interface and an output interface at edges of the circuit board 2 respectively. The input interface and the output interface are configured to be connected to external structures to realize signal transmission. As shown in FIG. 3, the length of the arc-shaped edge of the circuit board 2 is short, the rotatable range of the adjusting structure 4 is small accordingly, and the arc length of the arc-shaped internal gear 33 is also short. FIG. 4 shows a phase shifter including a circuit board 2 having a long arc-shaped edge, and the first strip line 21 is not shown in FIG. 4. The rotatable range of the adjusting structure 4 in this phase shifter is large, and the arc length of the arc-shaped internal gear 33 is long. The arc-shaped internal gear 33 and the circuit board 2 are disposed on two sides of the supporting board 1. Therefore, even if the arc edge of the arc-shaped internal gear 33 has a long length, the arc-shaped internal gear 33 does not cover the first stripe line 21 and does not affect the performance of the phase shifter. The arc-shaped internal gear 33 of a uniform specification and same arc length can be applied by the phase shifters with different adjusting lengths, thereby effectively improving the modularization of design of the phase shifter.

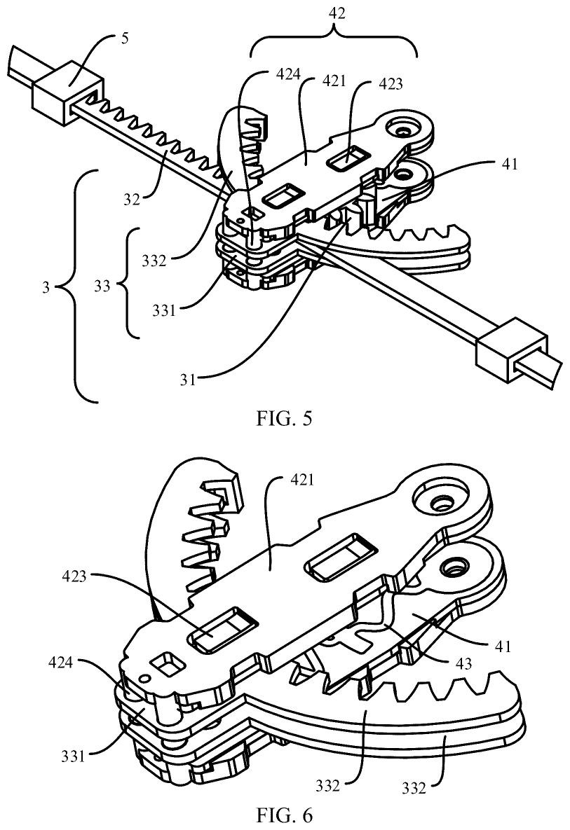

Taking the phase shifter with circuit board 2 having a long arc-shaped edge shown in FIG. 4 as an example, FIG. 5 to FIG. 10 are schematic diagrams respectively showing different structures of the phase shifter.

As shown in FIG. 5 to FIG. 7, the transmission structure 3 includes a gear 31, a gear rack 32 and an arc-shaped internal gear 33. The gear 31 is rotatably connected to the supporting board 1, and is engaged with gear rack 32 and the arc-shaped internal gear 33. The gear 31 rotates with a pin shaft 7 protruding from the supporting board 1 serving as its rotating shaft. In some embodiments, an elastic snap fastener is provided as the rotating shaft of the gear 31. The gear rack 32 and the arc-shaped internal gear 33 are disposed on a same side of the gear 31. Two ends of the gear rack 32 run through limiting members 5 respectively, and the gear rack 32 is limited by the limiting members 5. During phase shifting, the part of the gear rack 32 where the teeth-like portion is formed basically move between the two limiting members 5. A connecting portion 331 extends outward in the radial direction from the middle of the arc-shaped internal gear 33. A connecting portion 424 protrudes from the end of the sliding plate housing 42 of the adjusting structure 4. The arc-shaped internal gear 33 and the adjusting structure 4 are connected via the connecting portion 331 and the connecting portion 424. For the arc-shaped internal gear 33, the limiting members 5 define a space between the gear rack 32 and the supporting board 1 for accommodating part of the arc-shaped internal gear 33, thereby achieving vertical limiting of the arc-shaped internal gear 33. In the horizontal direction, the arc-shaped internal gear 33 is limited by the engagement with the gear 31 and the connection with the adjusting structure 4. Therefore, the arc-shaped internal gear 33 rotates without being connected to a solid rotating shaft. The gear rack 32 and the arc-shaped internal gear 33 are jointly in engagement connection with the gear 31. Therefore, the movement of the gear rack 32 can achieve backlash-free transmission through the engagement between the gear rack 32 and the gear 31, as well as the engagement between the gear 31 and the arc-shaped internal gear 33. This enables more precise phase adjustment and enhances the reliability of the phase shifter.

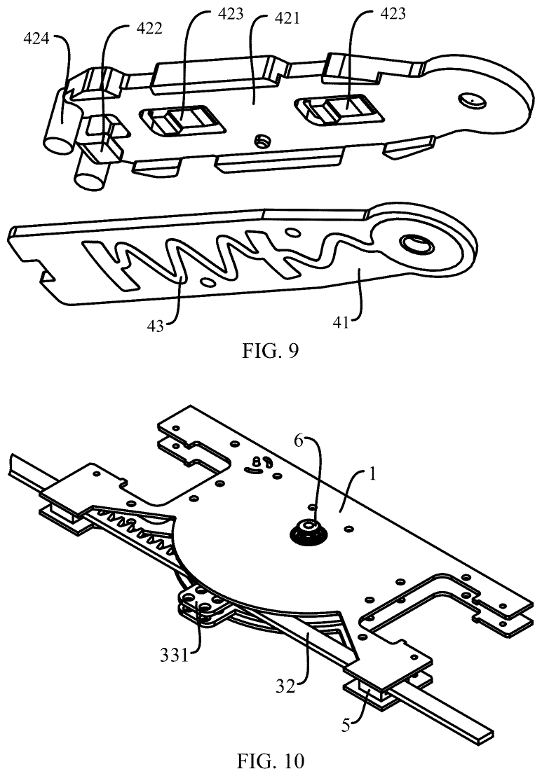

As shown in FIG. 5, FIG. 6, FIG. 8, and FIG. 9, the adjusting structure includes a sliding plate 41 and a sliding plate housing 42. The sliding plate housing 42 is installed on an outer side of the sliding plate 41, an inner side of the sliding plate 41 is provided with the second strip line 43, and the part of the second strip line 43 not in contact with the first strip line 21 is electrically connected to an external structure and is grounded. In some embodiments, an end of the second strip line 43 closer to the rotating shaft is electrically connected to the external structure. The sliding plate housing 42 includes a housing body 421 and a hook structure 422. The hook structure 422 is formed at the end of the sliding plate housing 42 close to the connecting portion 424, and is in snap connection with the inner end face of the sliding plate 41, thereby realizing the limiting of the sliding plate 41. According to shapes of the housing body 421 and the hook structure 422, an end, in contact with the hook structure 422, of the sliding plate 41 is provided with an avoidance slot or not provided with such avoidance slot. In some embodiments, a positioning column protruding from a side of the housing body 421 close to the sliding plate 41 is provided. The positioning column corresponds to a positioning slot of the sliding plate 41, thereby realizing the positioning of the sliding plate 41. In some embodiments, a positioning edge extends from the housing body 421 to wrap around the edge of the sliding plate 41, and the positioning edge provides further limiting to the sliding plate 41 and protects the edge of the sliding plate 41. The connecting portion 424 is provided at an end of the housing body 421. In some embodiments, the connecting portion 424 may be provided on two sides of the hook structure 422 or provided on a front end of the hook structure 422, thereby realizing connection of the adjusting structure 4 and the connecting member 331 of the arc-shaped internal gear 33. With the connection of the connecting member 424 and the connecting member 331, the adjusting structure 4 rotates along with the arc-shaped internal gear 33, and thus, the second strip lie 43 contacts and is electrically connected to different positions of the first strip line 21. Therefore, phase changing is accurately controlled, and the reliability of the phase shifter is improved.

In some embodiments, as shown in FIG. 9, the housing body 421 of the sliding plate housing 42 is provided with a plurality of slots. An elastic sheet 423 is arranged in the slot. The slot may form a U-shape, V-shape, or other similar shapes. In some embodiments, the number of the elastic sheets 423 may be two, three, or more. A position of the elastic sheet 423 corresponds to a position of the second strip line 43 that is in contact with the first strip line 21. The elastic sheet 423 pushes the sliding plate 41 to make the second strip line 43 be in close contact with the circuit board 2, thereby preventing false connection of the circuit, ensuring the grounding effect, and preventing it from affecting the performance of the phase shifter.

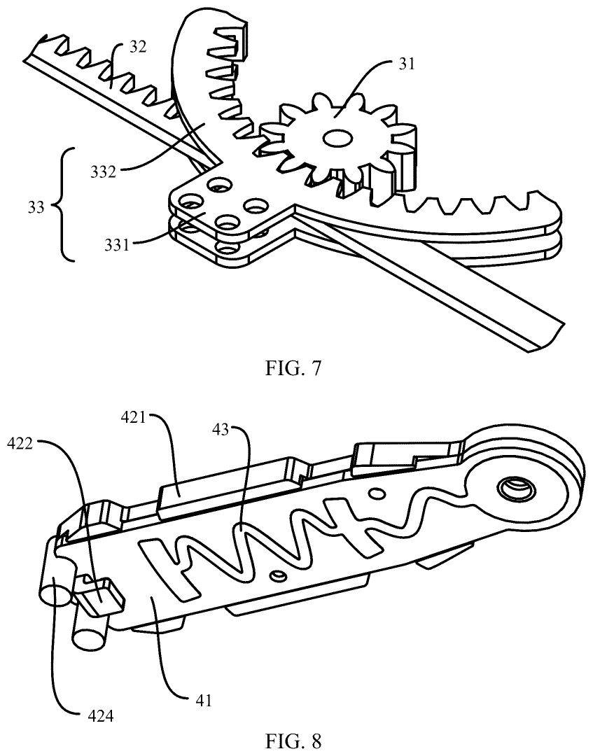

For the phase shifter including a single circuit board, reference of the phase adjusting can be made to FIG. 11, FIG. 4, FIG. 5, and FIG. 7. FIG. 11 shows the structure of the first strip line 21 of the phase shifter. The gear rack 32 is limited by two limiting members 5, moves along its length direction, and drives the gear 31 engaged with the gear rack 32 to rotate. The rotation of the gear 31 drives the arc-shaped internal gear 33 engaged with the gear 31 to rotate. The arc-shaped internal gear 33 drives, through the connecting portion 331 and the connecting portion 424, the adjusting structure 4 to rotate around the rotating shaft 6. The rotation of the arc-shaped internal gear 33 is coaxial with that of the adjusting structure 4, that is, they rotate around the axis where the rotating shaft 6 is located. The sliding plate 41 rotates following the arc-shaped internal gear 33. At the same time, the elastic sheet 423 presses the sliding plate 41 tightly, enabling the second strip line 43 to be in close contact with the first strip line 21. The second strip line 43 contacts and is electrically connected to different positions of the first strip line 21, thereby achieving phase shifting. Since the connection between the arc-shaped internal gear 33 and the adjusting structure 4 is realized through the connecting portion 331 and the connecting portion 424, the size and detailed specifications of the engagement between the teeth-like portion of the arc-shaped internal gear 33 and the gear 31 can be arranged in phase shifters of different specifications in a modular manner. For circuit boards 2 with different radii, it is only necessary to change the lengths or structures of the connecting portion 331 and the connecting portion 424, without modifying the teeth-like portion of the arc-shaped internal gear 33 or the gear 31. This not only enables precise control of phase changes but also facilitates coordination between multiple phase shifters and improves the reliability of the phase shifters.

In some embodiments, according to actual requirements of phase adjusting, multiple driving methods can also be realized by assembling and combining the various components of the phase shifter. For example, one gear rack 32 drives to realize phase adjusting of two circuit boards 2, which is called the “one-driving-two” mode. For another example, one gear rack 32 drives to realize phase adjusting of four circuit boards 2, which is called the “one-driving-four” mode. For the “one-driving-two” mode, the two circuit boards 2 may be disposed vertically or horizontally.

For the two circuit boards 2 disposed vertically to realize the “one-driving-two” mode, reference can be made to FIG. 4 to FIG. 7. The number of the adjusting structures 4 is two, the number of the circuit boards 2 is two, and the number of the supporting boards 1 is two. The two adjusting structures 4 are symmetrically disposed on two sides of the transmission structure 3 in the vertical direction, the two circuit boards 2 are symmetrically disposed on two sides of the transmission structure 3 in the vertical direction, and the two supporting boards 1 are symmetrically disposed on two sides of the transmission structure 3 in the vertical direction. The adjusting structure 4, the circuit board 2 and the supporting board 1 are disposed gradually closer to the transmission structure 3 in the vertical direction. The two limiting members 5 are both disposed between the two supporting boards 1. Two ends of the gear rack 32 run through the two limiting members 5 respectively, and the gear rack 32 is limited by the two limiting members 5. The gear portion of the gear rack 32 is disposed on a side facing the gear 31 and is engaged with the gear 31. The arc-shaped internal gear 33 includes two arc-shaped plates 332 each having a teeth-like portion. An end of one of the two arc-shaped plates 332 is connected to an end of the other one of the two arc-shaped plates 332. The two arc-shaped plates 332 are parallel in the vertical direction, and the teeth-like portions of the two arc-shaped plates 332 are both engaged with the gear 31. Each arc-shaped plate 332 is provided with a connecting portion 331 on its outer side. The two connecting portions 331 of the two arc-shaped plates 332 are connected to the two connecting portions 424 of the two adjusting structures 4 respectively. In some embodiments, for each connecting portion 331, a length of the connecting portion 424 is configured in such a manner that the connecting portion 424 extends to inner end surface of the connecting portion 331 and stops at the inner end surface, without further extension. That is, the connecting portions 424 corresponding to the two connecting portions 331 are not connected to each other. The gear rack 32 is disposed between two arc-shaped plates 332. When the gear rack 32 moves, the gear rack 32 drives the arc-shaped internal gear 33 to rotate, and the two connecting portions 331 will not hinder the movement of the gear rack 32. That is, the two arc-shaped plates 332 are symmetrically arranged on two sides of the gear rack 32 in the vertical direction, and the two adjusting structures 4 are symmetrically arranged on two sides of the gear rack 32 in the vertical direction.

During the phase shifting, as shown in FIG. 4 to FIG. 7, the gear rack 32 moves and drives the gear 31 to rotate, the rotation of the gear 31 drives two arc-shaped plates 332 located on two sides of the gear rack 32 to rotate. At the same time, the two adjusting structures 4 rotate simultaneously following the rotation of the two arc-shaped plates 332 respectively. Therefore, the second strip line 43 in each of the two adjusting structures 4 contacts and is electrically connected to different positions of the corresponding first strip line 21 in the two circuit boards 2, and thus, phase shifting is realized. In this embodiment, the gear rack 32 is disposed between two circuit boards 2, the gear 31 is driven to cause the two arc-shaped plates 332 to rotate, the rotation of the arc-shaped plates 332 drives the adjusting structures 4, the two circuit boards 2 of the phase shifter are installed in the vertical direction and share one gear 31 and gear rack 32, thereby improving the space utilization of the phase shifter, making the spatial layout more compact, and enabling the miniaturization of the phase shifter.

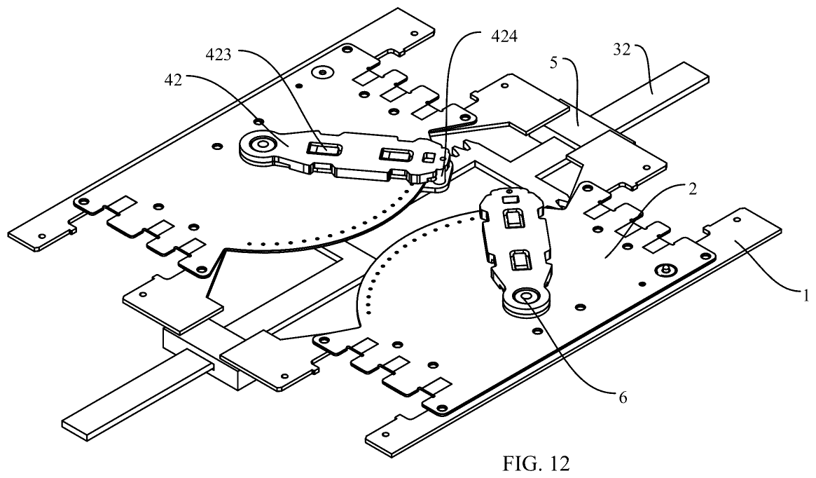

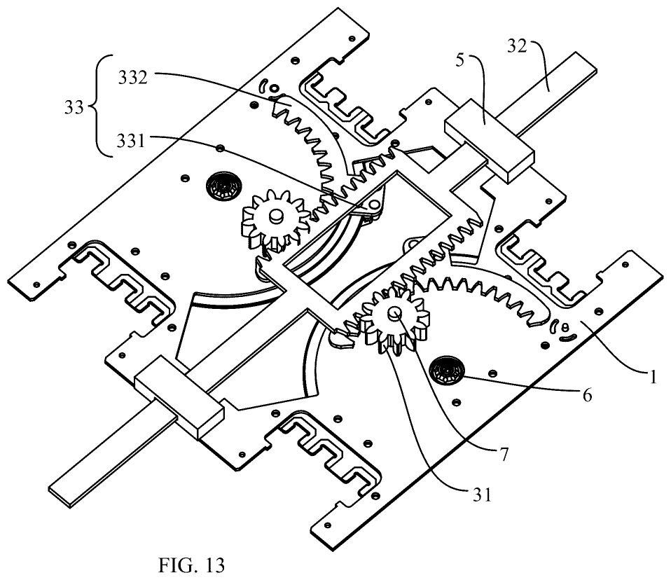

For the two circuit boards 2 disposed horizontally to realize the “one-driving-two” mode, reference can be made to FIG. 12 to FIG. 13. The number of the adjusting structures 4 is two, the number of the circuit boards 2 is two, the number of the supporting boards 1 is two, the number of the gears 31 is two, and the number of the arc-shaped internal gears 33 is two. The two adjusting structures 4 are symmetrically disposed on two sides of the gear rack 3 in the horizontal direction, the two circuit boards 2 are symmetrically disposed on two sides of the gear rack 32 in the in the horizontal direction, the two supporting boards 1 are symmetrically disposed on two sides of the gear rack 32 in the in the horizontal direction, the two gears 31 are symmetrically disposed on two sides of the gear rack 32 in the in the horizontal direction, and the two arc-shaped internal gears 33 are symmetrically disposed on two sides of the gear rack 32 in the in the horizontal direction. One adjusting structure 4, one circuit board 2, one supporting board 1, one gear 31, and one arc-shaped internal gear 33 form one parallel phase shifting assembly. Two limiting members 5 are connected to two supporting boards 1 respectively. The gear rack 32 has two sides facing the two parallel phase shifting assemblies respectively, and the gear rack 32 includes teeth-like portions provided on the two sides and engaged with the two gears 31 respectively. In some embodiments, the two circuit boards 2 have large sizes, and a distance between the gear 31 and the edge of the corresponding circuit board 2 is large, the parts of the gear rack 32 where the teeth-like portions are formed are translated to two sides, such that the gear 31 of each parallel phase shifting assembly is engaged with the gear rack 32. In each parallel phase shifting assembly, the arc-shaped internal gear 33 is connected to the adjusting structure 4 and is engaged with the gear 31. As shown in FIG. 13, the arc-shaped internal gear 33 is limited in the vertical direction by the gear rack 32 and the supporting board 1. The two gears 31 rotate around two pin shafts 7 on the two supporting boards 1 respectively. In some embodiments, an end of the pin shaft 7 is provided with an elastic snap fastener, and the gear 31 is limited to the supporting board 1 by the elastic snap fastener. In another embodiment, the pin shaft 7 is not provided with the elastic snap fastener, the gear 31 is limited in the vertical direction through cooperation of an external structure and the supporting board 1 during installation.

As shown in FIG. 12 and FIG. 13, during the phase shifting, the gear rack 32 moves and drives the two gears 31 to rotate, the rotation of the two gears 31 drives the two arc-shaped internal gears 33 to rotate, the two adjusting structures 4 rotate simultaneously following the two arc-shaped internal gears 33, such that each second strip line 43 in the two adjusting structures 4 contacts and is electrically connected to different positions of the corresponding first strip line 21 on the two circuit boards 2 for phase shifting.

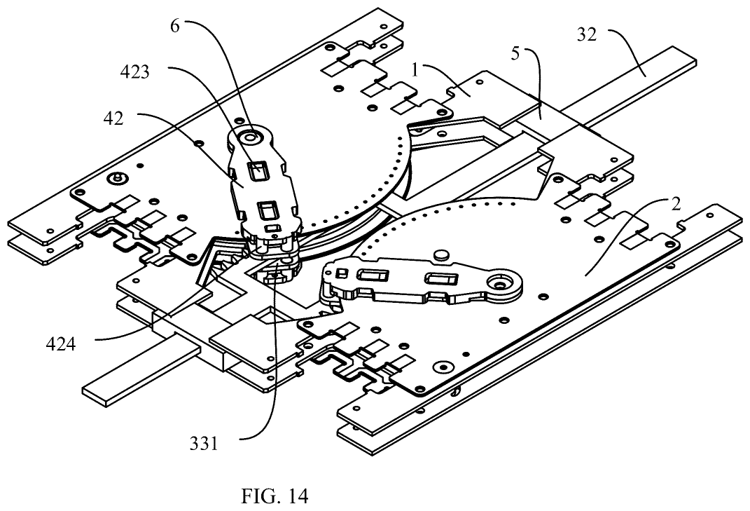

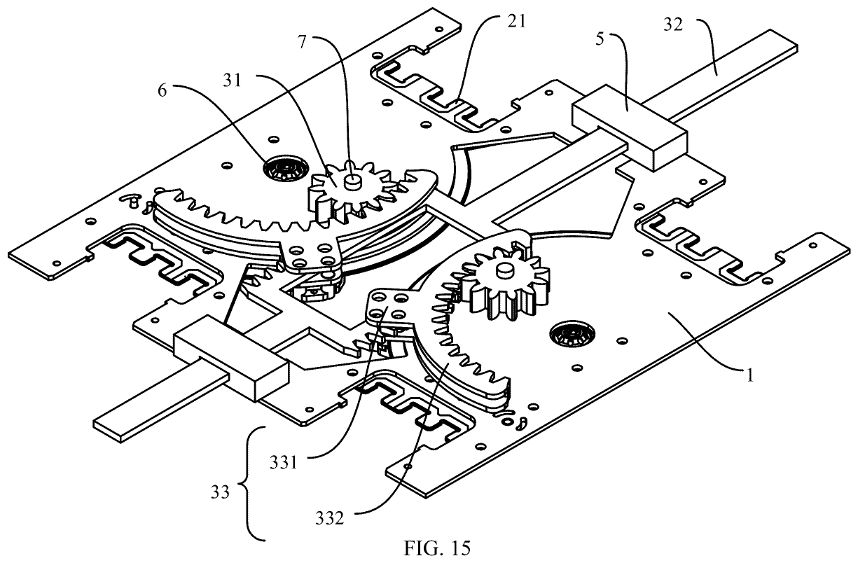

For the phase shifter using four circuit boards 2 to realize the “one-driving-four” mode, reference can be made to FIG. 14 and FIG. 15. The number of the adjusting structures 4 is four, the number of the circuit boards 2 is four, the number of the supporting boards 1 is four, the number of the arc-shaped internal gears 33 is two, and the number of gears 31 is two. Two adjusting structures 4, two circuit boards 2, two supporting boards 1, one arc-shaped internal gear 33 and one gear 31 form a vertical phase shifting assembly. The two vertical phase shifting assemblies are disposed on two sides of the gear rack 32 in the horizontal direction. Each limiting member 5 is connected to two supporting boards 1 in the vertical direction and is connected to two supporting boards 1 in the horizontal direction. That is, four supporting boards 1 are respectively connected to the four corners of each limiting member 5 on the vertical interface. The gear rack 32 has two sides facing the two parallel phase shifting assemblies, and the gear rack 32 includes teeth-like portions on the two sides. The teeth-like portions are engaged with the two gears 31 respectively. In some embodiments, the two circuit boards 2 have large sizes, and the distance between the gear 31 and the edge of the circuit board 2 is large. The parts of the gear rack 32 where the teeth-like portions are formed are translated to two sides, such that the gear 31 of each vertical phase shifting assembly is engaged with the gear rack 32.

As shown in FIG. 15, in each vertical phase shifting assembly, two adjusting structures 4 are disposed on two sides of the gear 31 in the vertical direction, two circuit boards 2 are disposed on two sides of the gear 31 in the vertical direction, two supporting boards 1 are disposed on two sides of the gear 31 in the vertical direction, and the adjusting structure 4, the circuit board 2, and the supporting board 1 are disposed from the outer side to the inner side. Each arc-shaped internal gear 33 includes two arc-shaped plates 332 each including a teeth-like portion. An end of one of the two arc-shaped plates 332 is connected to an end of the other of the two arc-shaped plates 332. The two arc-shaped plates 332 are disposed in parallel along the vertical direction and disposed on two sides of the gear rack 32 in the vertical direction. The teeth-like portion is engaged with the gear 31. Each arc-shaped plate 332 is provided with a connecting portion 331 on its outer side. Two connecting portions 331 are connected to two connecting portions 424 of the two adjusting structures 4 respectively. For each connecting portion 331, a length of the connecting portion 424 is configured in such a manner that the connecting portion 424 extends to the inner end surface of the connecting portion 331 and stops at the inner end surface, without further extension. The gear rack 32 is disposed between two arc-shaped plates 332. When the gear rack 32 moves and drives the arc-shaped internal gears 33 to rotate, the two connecting portions 331 will not hinder the movement of the gear rack 32.

During the phase shifting, as shown in FIG. 14 and FIG. 15, the gear rack 32 moves and drive the two gears 31 of the two vertical phase shifting assemblies to rotate, and the rotation of the two gears 31 drives the four arc-shaped plates 332 of the two arc-shaped internal gears 33 to rotate. The four adjusting structures 4 rotate simultaneously along with the four arc-shaped plates 332 respectively, enabling each second strip line 43 of the four adjusting structures 4 in the two vertical phase shifting assemblies to contact and be electrically connected to different positions of the corresponding first strip line 21 on the four circuit boards 2, thereby achieving phase shifting. For each vertical phase shifting assembly, the gear rack 32 is disposed between two circuit boards 2, the gear 31 drives two arc-shaped plates 332, the arc-shaped plate 332 drives the adjusting structures 4, such that two circuit boards 2 share one gear 31 and gear rack 32, thereby improving the space utilization of the phase shifter, making the spatial layout more compact, and realizing the miniaturization of the phase shifter.

Embodiments of the present disclosure provide a phase shifter including a supporting board, a circuit board, a transmission structure, and an adjusting structure. The circuit board is disposed on an outer side of the supporting board, and the transmission structure is disposed on a side of the supporting board away from the circuit board. The adjusting structure is disposed on an outer side of the circuit board and rotatably connected to the circuit board and the supporting board. The transmission structure includes a gear, a gear rack and an arc-shaped internal gear. The gear is engaged with the gear rack and the arc-shaped internal gear, and the arc-shaped internal gear is connected to the adjusting structure. A first strip line is provided on the circuit board, and a second strip line is provided on the adjusting structure. The gear rack moves to drive the gear to rotate, and thus the arc-shaped internal gear rotates. The adjusting structure rotates following the rotation of the arc-shaped internal gear to cause the second strip line of the adjusting structure to contact and be electrically connected to different positions of the first strip line. Therefore, phase changing is accurately controlled, the interference on the strip line is reduced, multiple phase shifters can cooperate better, and the reliability of the phase shifter is improved.

The above embodiments are exemplary embodiments of the present disclosure and are not intended to limit the present disclosure. The present disclosure may be subject to various modifications and variations to those skilled in the art. Any modifications, equivalent substitutions or improvements that are within the spirit and principle of the disclosure are intended to be covered by the protection scope of the disclosure.

I/We claim:

1. A phase shifter, comprising:
a supporting board;
a circuit board disposed on an outer side of the supporting board, wherein a first strip line for phase shifting is disposed on the circuit board;
a transmission structure disposed on a side of the supporting board away from the circuit board, wherein the transmission structure comprises a gear, a gear rack and an arc-shaped internal gear, the gear is rotatably connected to the supporting board and is engaged with the gear rack and the arc-shaped internal gear, and the gear rack and the arc-shaped internal gear are disposed on a same side of the gear; and
an adjusting structure disposed on an outer side of the circuit board and rotatably connected to the circuit board and the supporting board, wherein an end of the adjusting structure is connected to an outer side of the arc-shaped internal gear, and a side of the adjusting structure in contact with the circuit board is provided with a second strip line which is electrically connected to the first strip line and in contact with the first strip line,
wherein the gear rack moves along its length direction and drives the gear to rotate, the gear drives the arc-shaped internal gear to rotate, and the adjusting structure rotates along with the rotation of the arc-shaped internal gear to cause the second strip line to contact and be electrically connected to different positions of the first strip line to realize phase shifting.

2. The phase shifter according to claim 1, wherein the arc-shaped internal gear is provided with a connecting portion extending outward in a radial direction from a middle portion of the arc-shaped internal gear, the adjusting structure is provided with a connecting portion protruding from an end of the adjusting structure, and the connecting portion of the adjusting structure is connected to the connecting portion of the arc-shaped internal gear.

3. The phase shifter according to claim 1, wherein the adjusting structure comprises a sliding plate and a sliding plate housing, the sliding plate housing is arranged on an outer side of the sliding plate, an inner side of the sliding plate is provided with the second strip line, and the second strip line is electrically connected to the circuit board and in contact with the circuit board.

4. The phase shifter according to claim 3, wherein the sliding plate housing comprises a housing body and a hook structure, the hook structure is disposed at an end of the sliding plate housing close to the connecting portion of the adjusting structure, and the hook structure and an inner surface of the sliding plate are in snap connection.

5. The phase shifter according to claim 3, wherein the sliding plate housing is provided with a plurality of slots, each slot is provided with an elastic sheet therein, the elastic sheet presses the sliding plate to cause the second strip line and the circuit board to be in contact with each other.

6. The phase shifter according to claim 1, further comprising a first limiting block and a second limiting block, wherein the first limiting block and the second limiting block are connected to two ends of the supporting board, respectively, and two ends of the gear rack run through the first limiting block and the second limiting block in a movable manner, respectively.

7. The phase shifter according to claim 1, wherein a side of the circuit board is formed into an arc-shaped edge, and a side edge of the supporting board follows a shape of a side edge of the circuit board.

8. The phase shifter according to claim 1, wherein the adjusting structure comprises two adjusting structures disposed symmetrically on two sides of a vertical direction of the transmission structure, the circuit board comprises two circuit boards disposed symmetrically on two sides of the vertical direction of the transmission structure, the supporting board comprises two supporting boards disposed symmetrically on two sides of the vertical direction of the transmission structure, and the adjusting structure, the circuit board and the supporting board are disposed gradually closer to the vertical direction of the transmission structure,
the arc-shaped internal gear comprises two arc-shaped plates each having a teeth-like portion, an end of one of the two arc-shaped plates is connected to an end of another one of the two arc-shaped plates, the two arc-shaped plates are parallel to each other and disposed along the vertical direction, the two arc-shaped plates are connected to the two adjusting structures respectively, and the teeth-like portions of the two arc-shaped plates are both engaged with the gear,
the gear rack moves to drive the gear to rotate, the gear drives the two arc-shaped plates to rotate, and the two adjusting structures rotate respectively along with the two arc-shaped plates simultaneously, such that each of the second strip lines of the two adjusting structures contacts different positions of the corresponding first strip line of the two circuit boards respectively for phase shifting.

9. The phase shifter according to claim 8, wherein each of the two arc-shaped plates is provided with a connecting portion on its outer side, the two connecting portions are connected to the two adjusting structures respectively, and the gear rack is arranged between the two arc-shaped plates and is engaged with the gear.

10. The phase shifter according to claim 1, wherein the adjusting structure comprises two adjusting structures symmetrically arranged on two sides of the gear rack in a horizontal direction, the circuit board comprises two circuit boards symmetrically arranged on two sides of the gear rack in the horizontal direction, the supporting board comprises two supporting boards symmetrically arranged on two sides of the gear rack in the horizontal direction, the gear comprises two gears symmetrically arranged on two sides of the gear rack in the horizontal direction, and the arc-shaped internal gear comprises two arc-shaped internal gears symmetrically arranged on two sides of the gear rack in the horizontal direction,
a first one of the two adjusting structures, a first one of the circuit boards, a first one of the two supporting boards, a first one of the two gears, and a first one of the two arc-shaped internal gears form a first parallel phase shifting assembly,
a second one of the two adjusting structures, a second one of the circuit boards, a second one of the two supporting boards, a second one of the two gears, and a second one of the two arc-shaped internal gears form a second parallel phase shifting assembly,
in each of the first parallel phase shifting assembly and the second parallel phase shifting assembly, the arc-shaped internal gear is connected to the adjusting structure and is engaged with the gear,
the gear rack comprises two teeth-like portions on its two sides, and the two teeth-like portions are engaged with the two gears,
the gear rack moves to drive the two gears to rotate, the two gears drive the two arc-shaped internal gears to rotate, and the two adjusting structures rotate respectively along with the two arc-shaped internal gears simultaneously, such that the second strip lines of the two adjusting structures contact different positions of the first strip lines of the two circuit boards respectively for phase shifting.

11. The phase shifter according to claim 1, wherein the adjusting structure comprises four adjusting structures, the circuit board comprises four circuit boards, the supporting board comprises four supporting boards,
the gear comprises two gears, and the arc-shaped internal gear comprises two arc-shaped internal gears,
two adjusting structures, two circuit boards, two supporting boards, one gear, and one arc-shaped internal gear form a first vertical phase shifting assembly,
another two adjusting structures, another two circuit boards, another two supporting boards, another one gear, and another one arc-shaped internal gear form a second vertical phase shifting assembly,
the first vertical phase shifting assembly and the second vertical phase shifting assembly are symmetrically arranged on two sides of the gear rack in a horizontal direction,
the gear rack comprises two teeth-like portions on its two sides, and the two teeth-like portions are respectively engaged with the gear of the first vertical phase shifting assembly and the gear of the second vertical phase shifting assembly,
the gear rack moves to drive the two gears to rotate, the two gears drive the four arc-shaped plates of the two arc-shaped internal gears to rotate, and the four adjusting structures rotate respectively along with the four arc-shaped plates simultaneously, such that each of the second strip lines of the four adjusting structures contacts different positions of the corresponding one of the first strip lines of the four circuit boards respectively for phase shifting.

12. The phase shifter according to claim 11, wherein, in each of the first vertical phase shifting assembly and the second vertical phase shifting assembly, the two adjusting structures are symmetrically arranged on two sides of the gear in a vertical direction, the two circuit boards are symmetrically arranged on two sides of the gear in the vertical direction, the two supporting boards are symmetrically arranged on two sides of the gear in the vertical direction, and the adjusting structures, the two circuit boards and the two supporting boards are disposed gradually closer to the gear,
each arc-shaped internal gear comprises two arc-shaped plates each having a teeth-like portion,
an end of one of the two arc-shaped plates is connected to an end of another one of the two arc-shaped plates, the two arc-shaped plates are parallel to each other and disposed along the vertical direction, and the two arc-shaped plates are respectively arranged on two sides of the gear rack in the vertical direction,
the teeth-like portions of the two arc-shaped plates are both engaged with the gear,
each arc-shaped internal gear is provided with a connecting portion on its outer side, and the two connecting portions are respectively connected to the two adjusting structures that are arranged on two sides of the gear in the vertical direction.
